(19) United States
(12) Patent Application Publication
(10) Pub. No.: US 2007/0089464 A1
(43) Pub. Date: Apr. 26, 2007

(54) Apparatus for fabricating soot preform

(75) Inventors: Yun-Ho Kim, Daegu (KR); Mun-Hyun Do, Chilgok-gun (KR); Ho-Jin Lee, Suwon-si (KR); Jin-Seong Yang, Gumi-si (KR); Jae-Hyeon Seong, Gimcheon-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/489,883

(22) Filed: Jul. 20, 2006

(30) Foreign Application Priority Data
Oct. 21, 2005 (KR) 99642 /2005

(51) Int. Cl. C03B 37/07; C03B 37/018

(52) U.S. Cl. 65/488; 65/531

(57) ABSTRACT

An apparatus for fabricating a soot preform includes at least one torch for depositing soot generated by flame hydrolysis on the soot preform. A vaporizer vaporizes a liquid source material. A heater heats a dilution gas. The vaporizer and the heater respectively supply, to the torch, the vaporized source material and the heated dilution gas together through a single pipe.

### CLAIM TO PRIORITY

This application claims priority to an application entitled “Apparatus for Fabricating Soot Preform,” filed with the Korean Intellectual Property Office on Oct. 21, 2005 and assigned Serial No. 2005-99642, the entire disclosure of which is hereby incorporated by reference.

### BACKGROUND OF THE INVENTION

1. Field of the Invention

The present invention relates to an apparatus and method for fabricating an optical fiber preform, and more particularly to an apparatus and method for fabricating a soot preform by flame hydrolysis.

2. Description of the Related Art

Generally, optical fiber preforms are fabricated using outside vapor deposition or inside vapor deposition. The outside vapor deposition method includes outside vapor phase deposition (OVD) and vapor phase axial deposition (VAD) which are often-used, commercialized methods.

In OVD and VAD, a plurality of torches is used to generate a flame. Soot generated by flame hydrolysis is deposited on a starting rod to produce a soot preform which is then sintered to form an optical fiber preform.

VAD deposits soot on a starting rod aligned on a vertical axis using torches so that a core and a cladding can be axially grown upon the rod to produce a soot preform.

During the deposition of soot, a number of materials are supplied to the torches. These include a source material composed of a glass-forming material SiCl₄ and a refractive index controlling material, such as GeCl₄ or POCl₃, a fuel gas composed of hydrogen H₂ or a hydrocarbon combustible material, an oxidation gas composed of oxygen O₂ for generating a flame upon combustion reaction with the fuel gas, and an inert gas composed of argon Ar for controlling a chemical reaction and the temperature of the flame. Generally, coaxial multi-port torches are used. A single coaxial multi-port torch includes a plurality of coaxial tubes which are concentrically arranged relative to one another. When a coaxial 4-port torch is used, a source material is supplied to a central port of the torch, a fuel gas to a first outer port, an inert gas to a second outer port and an oxidation gas to a third outer port. The central port and the first to third outer ports are disposed, respectively, from the center to the outer perimeter of the torch.

Since a source material, such as SiCl₄, is normally in a liquid state, it should first be vaporized in order to be supplied to the torch. In this connection, the following methods are available for vaporization.

A first vaporization method uses a bubbler. The bubbler contains a liquid source material in an appropriate temperature condition and releases a carrier gas into the source material to generate bubbles within the source material, thereby vaporizing the source material.

A second vaporization method uses a vaporizer. The vaporizer contains a liquid source material and vaporizes the source material by heating to a temperature higher than the boiling point of the source material.

The above vaporization methods heat and insulate a pipe that connects the bubbler (or the vaporizer) to the torch. The pipe serves as a delivery passage for the source material in order to prevent condensation of the source material during delivery.

In the first method using a bubbler, the pipe connecting the bubbler to the torch can be kept at a relatively low temperature, which lowers the management cost.

However, the first method has relatively low productivity. When the amount of the source material is increased to accelerate the deposition speed, an increased amount of a carrier gas is used, which lowers the temperature of the flame and increases the flow rate of the source material. As a result, the deposition rate and efficiency will both be decreased.

The second method using a vaporizer regulates the temperature for heating the source material, without using a carrier gas. Therefore, this method can easily increase the amount of the source material supplied to the torch with higher productivity.

The second method, however, incurs a relatively high management cost. The pipe connecting the vaporizer to the torch for the delivery of the source material should be kept at a high temperature. This shortens the life of a heating cable installed on the pipe, makes it difficult to insulate the pipe and increases the possibility of fire.

It is accordingly highly demanded that an apparatus for fabricating a soot preform with high productivity and low management cost be provided.

### SUMMARY OF THE INVENTION

The present invention has been made to solve the above-mentioned problems occurring in the prior art, and, in an aspect of the present invention, there is provided an apparatus for fabricating a soot preform with high productivity and low management cost.

In one embodiment, there is provided an apparatus for fabricating a soot preform. The apparatus includes at least one torch for depositing soot generated by flame hydrolysis on the soot preform. A vaporizer vaporizes a liquid source material. A heater heats a dilution gas. The vaporizer and the heater respectively supply, to the torch, the vaporized source material and the heated dilution gas together through a single pipe.

### BRIEF DESCRIPTION OF THE DRAWINGS

The above features and advantages of the present invention will be more apparent from the following detailed description taken in conjunction with the accompanying drawings, in which:

FIG. 1 is an exemplary embodiment illustrative of an apparatus for fabricating a soot preform according to a preferred embodiment of the present invention; and

FIG. 2 is a view illustrating the first torch in FIG. 1, or an identically-structured second torch.

### DETAILED DESCRIPTION OF THE INVENTION

Hereinafter, an embodiment of the present invention will be described with reference to the accompanying drawings. In the drawings, the same element, although depicted in different drawings, will be designated by the same reference numeral or character. For the purposes of clarity and simplicity, descriptions of well-known functions and constructions are omitted for clarity and conciseness.

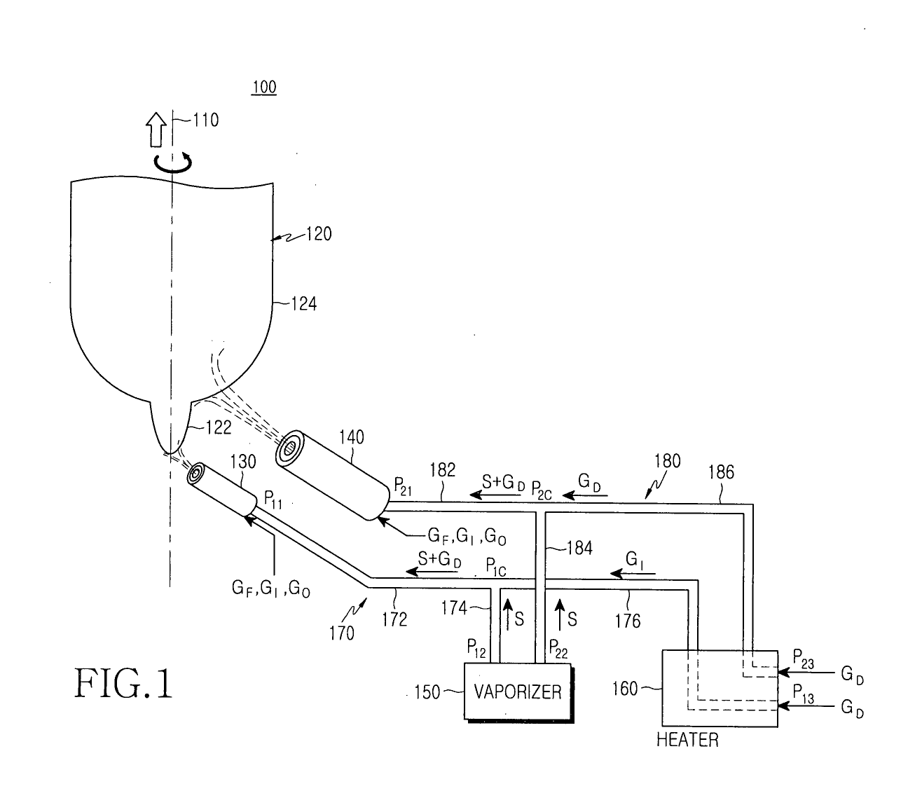

FIG. 1 shows, by way of illustrative and non-limitative example, an apparatus for fabricating a soot preform according to a preferred embodiment of the present invention. The apparatus 100 includes first and second torches 130, 140 for producing soot, a vaporizer 150 for vaporizing a source material S, a heater 160 for heating a dilution gas G_{D}, and first and second pipes 170, 180.

A soot preform 120 aligned on a vertical axis 110 includes a starting glass rod, and a core 122 and a cladding 124 which are formed by depositing soot on the end of the starting rod. The core 122 has a relatively higher refractive index. The cladding 124 surrounding the core 122 has a relatively lower refractive index. At the beginning, the soot is deposited onto the end of the starting rod using the second torch 140 to form a ball. The deposition of soot is continued until a ball of a predetermined size is formed. Then, the core 122 and the cladding 124 are simultaneously formed on the ball using the first and second torches 130, 140. When the core and the cladding are grown directly on the end of the starting rod without forming the ball, the soot preform 120 separates from the starting rod or develops a crack due to its own weight.

During the deposition of soot, the soot preform 120 rotates and moves upward at a predetermined speed. Specifically, the soot preform 120 rotates symmetrically around a vertical axis 110. Also, the soot preform 120 moves upward along the vertical axis 110 to constantly grow in a downward direction. Hereinafter, the growth direction of the soot preform 120 refers to the downward direction.

The longitudinal axis of the first torch 130 is inclined at an acute angle relative to the vertical axis 110. The first torch 130 directs a flame toward the end of the soot preform 120 so that the core 122 can be grown downward from the end of the soot preform 120. A source material S composed of a glass-forming material SiCl₄ and a refractive index controlling material, such as GeCl₄, a dilution gas G_{D} composed of helium (He), a fuel gas G_{F} composed of hydrogen (H₂), an inert gas G_{I} composed of argon (Ar), and an oxidation gas G_{O} composed of oxygen (O₂) are supplied to the first torch 130.

The dilution gas G_{D} can be argon (Ar), krypton (Kr) or xenon (Xe). The refractive index controlling material can be GeCl₄ or POCl₃.

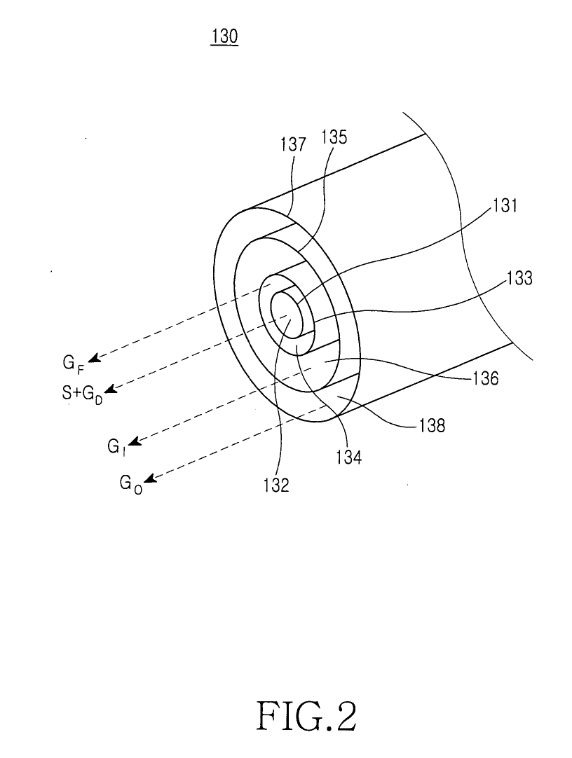

FIG. 2 is an exemplary embodiment of a cross-section of the first torch 130. The first torch 130 is a coaxial 4-port torch including four tubes 131, 133, 135, 137 which are coaxially and concentrically arranged relative to one another and radially spaced from each other to form four ports. The source material S and the dilution gas G_{D} are supplied to a central port 132 of the first torch 130, the fuel gas G_{F} to a first outer port 134, the inert gas G_{I} to a second outer port 136, and the oxidation gas G_{O} to a third outer port 138. The port 132 and the first to third outer ports 134, 136, 138 are disposed, respectively, from the center to the outer perimeter of the first torch 130.

The source material S is hydrolyzed in the flame directed from the first torch 130, thereby generating soot which will be deposited on the soot preform 120. Oxides SiO₂ and GeO₂ constituting the soot are produced by the following hydrolysis reactions.
SiCl₄+2H₂O→SiO₂+4HCl [Chemical formula 1]
GeCl₄+2H₂O→GeO₂+4HCl [Chemical formula 2]

The second torch 140 is located above, and spaced apart from, the first torch 130, and may be structured identically to the first torch 130. The longitudinal axis of the second torch 140 is, likewise, as in the case of the first torch 130, inclined at an acute angle relative to the vertical axis 110. The second torch 140 directs a flame toward the outer periphery of the core 122 so that the cladding 124 can be grown on the outer periphery of the core 122. A source material S composed of a glass-forming material SiCl₄, a dilution gas G_{D} composed of helium He, a fuel gas G_{F} composed of hydrogen (H₂), an inert gas G_{I} composed of argon Ar, and an oxidation gas G_{O} composed of oxygen (O₂) are supplied to the second torch 140. Like the first torch 130, the second torch 140 is a coaxial 4-port torch including four tubes 131, 133, 135, 137 which are coaxially and concentrically arranged relative to one another and radially spaced from each other to form four ports 132, 134, 136, 138. The source material S and the dilution gas G_{D} are supplied to a central port 132 of the second torch 140, the fuel gas G_{F} to a first outer port 134, the inert gas G_{I} to a second outer port 136, and the oxidation gas G_{O} to a third outer port 138. The central port 132 and the first to third outer ports 134, 136, 138 are disposed, respectively, from the center to the outer perimeter of the second torch 140.

The source material S is hydrolyzed in the flame directed from the second torch 140, thereby generating soot. The generated soot is deposited on the soot preform 120.

Different source materials S and different amounts of source materials S are supplied to the first torch 130 and the second torch 140 so that the core 122 can have a higher refractive index than the surrounding cladding 124. Chemicals, such as germanium and phosphor, increase the refractive index, whereas boron decreases the refractive index.

Each of the first and second pipes 170, 180 has first to third ports P₁₁, P₁₂, P₁₃, P₂₁, P₂₂, P₂₃ and a confluence P_{1C}, P_{2C}. The first ports P₁₁, P₂₁ are connected respectively to the first and second torches 130, 140. The second ports P₁₂, P₂₂ are connected to the vaporizer 150. At the third ports P₁₃, P₂₃, the dilution gas G_{D} is supplied. The source material S supplied to the second port P₁₂, P₂₂ and the dilution gas G_{D} supplied to the third port P₁₃, P₂₃ are mixed together at the confluence P_{1C}, P₂C and discharged through the first port P₁₁, P₂₁. Each of the first and second pipes 170, 180 preferably consists of a first branch 172, 182 connecting the first port P₁₁, P₂₁ to the confluence P_{1C}, P_{2C}, a second branch 174, 184 connecting the confluence P_{1C}, P_{2C} to the second port P₁₂, P₂₂, and a third branch 176, 186 connecting the confluence P_{1C}, P_{2C} to the third port P₁₃, P₂₃.

The vaporizer 150 contains liquid source materials S and vaporizes the liquid source materials by heating to a temperature higher than the each of the respective boiling points. Specifically, the vaporizer 150 contains SiCl₄ and GeCl₄ in a liquid form. After vaporizing the source materials, the vaporizer 150 supplies both SiCl₄ and GeCl₄ to the second port P₁₂ of the first pipe 170, and only SiCl₄ to the second port P₂₂ of the second pipe 180. SiCl₄ has a boiling point of 57.6° C., whereas GeCl₄ has a boiling point of 84° C. Accordingly, the vaporizer 150 heats SiCl₄ to a temperature higher than 57.6° C. and GeCl₄ to a temperature higher than 84° C. The heating temperature in the vaporizer 150 varies depending on source materials S.

The heater 160 heats the dilution gas G_{D} supplied to the third ports P₁₃, P₂₃ of the first and second pipes 170, 180 to a temperature above the higher of the two, respective boiling points of the source materials S. The heater 160 is installed on the third branches 176, 186 of the first and second pipes 170, 180, and preferably, on the ends of the third branches. The heater 160 may comprise a heating cable wound around the ends of the third branches 176, 186. The dilution gas G_{D} heated by the heater 160 is mixed with the corresponding source materials S and supplied to the first and second torches 130, 140.

In order to prevent condensation of the source materials S during delivery to the torches 130, 140, the first and second pipes 170, 180 are maintained at a temperature higher than the boiling points of the source materials S using a heat insulator and a heating cable. For example, a heating wire can be installed on many portions of the first and second pipes 170, 180 and covered with a heat insulator.

The heating temperature of the heater 160 is the same as that of the first and second pipes 170, 180, and preferably higher than the boiling points of the source materials S. In consideration of conventional source materials, the heating temperature of the heater 160 and the first and second pipes 170, 180 should be kept preferably in a range of 90 to 120° C., and, more preferably, at 95° C. or higher.

The heated dilution gas G_{D} prevents the vaporized source materials S from condensing during delivery through the pipes 170, 180 due to the drop in temperature. The heated dilution gas G_{D} reduces the time period during which the vaporized source materials S remain within the pipes 170, 180. Also, the dilution gas G_{D} having high thermal conductivity slows down the drop in temperature of the vaporized source materials S. It is preferable to use helium having the highest thermal conductivity among all dilution gases. When helium is used, the heating rate is rapidly increased, thereby reducing the time of heating in the heater 160.

Table 1 shows the relationship between the amount of the dilution gas G_{D} and the condensation probability of the source material S in the second pipe 180. The heating temperature of the heater 160 and the first and second pipes 170, 180 is 95° C.

TABLE 1

| | Amount of | |
|---|---|---|
| | Helium | Results |
| 1^{st} Experimental | 0 sccm | Condensation frequently occurs. |
| Example | | |
| 2^{nd} Experimental | 10 sccm | Condensation occasionally occurs |
| Example | | when the ambient temperature |
| | | changes. |
| 3^{rd} Experimental | 50 sccm | No condensation occurs. |
| Example | | |
| 4^{th} Experimental | 100 sccm | No condensation occurs. |
| Example | | |
| 5^{th} Experimental | 10000 sccm | No condensation occurs. Deposition |
| Example | | rate and efficiency are decreased |
| | | due to the increased flow rate of the |
| | | source material. |

As is clear from Table 1, the dilution gas G_{D} heated to a temperature between 90 and 120° C. should be supplied preferably in an amount of 10 to 100 standard cubic centimeters per minute (sccm). The supply rate of heated gas may therefore be maintained within the range from 10 to 100 sccm.

Although a preferred embodiment of the present invention has been described for illustrative purposes, those of ordinary skill in the art will recognize that various changes and modifications can be made without departing from the scope and spirit of the invention as disclosed in the accompanying claims, including the full scope of equivalents thereof.

The apparatus for fabricating a soot preform according to the present invention can be generally used in the production of a planar lightwave circuit (PLC). This apparatus can also be used in flame hydrolysis deposition (FHD) for forming a waveguide (or a core) and a cladding layer on a silicone substrate using a flame directed from a coaxial multi-port torch.

As explained above, the apparatus for fabricating a soot preform according to the present invention supplies a source material mixed with a heated dilution gas to a torch, thereby preventing condensation of the source material within a pipe for delivering the source material. Since the pipe can be maintained at a low temperature, the life of a heating cable installed on the pipe can be increased. Also, it is possible to reduce the cost of a heat insulator (i.e., the maintenance cost) and the possibility of fire.

The apparatus for fabricating a soot preform according to the present invention improves productivity in vaporizer usage and reduces the maintenance cost of using a heated dilution gas.

What is claimed is:

1. An apparatus for fabricating a soot preform, comprising:
at least one torch for depositing soot generated by flame hydrolysis on the soot preform;
a vaporizer for vaporizing a liquid source material to create vaporized source material;
a heater for heating a dilution gas to create a heated dilution gas; and
at least one pipe, said apparatus being configured such that the vaporizer and the heater respectively supply, to a given one of said at least one torch, said vaporized source material and said heated dilution gas together through a corresponding one of said at least one pipe.

2. The apparatus according to claim 1, wherein said heating is to a temperature higher than a boiling point of the source material to be vaporized.

3. A system comprising the apparatus according to claim 1, and further comprising said dilution gas, wherein said dilution gas comprises at least one of argon, krypton and xenon.

4. The apparatus according to claim 1, configured for maintaining the corresponding one pipe at a temperature higher than a boiling point of the source material to be vaporized.

5. The apparatus according to claim 1, configured for maintaining said heated dilution gas within a temperature range from 90° C. to 120° C., and for maintaining a supply rate of said heated dilution gas within a range from 10 to 100 sccm.

6. The apparatus of claim 1, configured so that said vaporized source material and said heated dilution gas mix in a part of the corresponding one pipe.

7. The apparatus of claim 6, wherein said corresponding pipe comprises two additional parts for respectively conveying said vaporized source material and said heated dilution gas.

8. The apparatus of claim 7, wherein the three parts are joined together at a confluence, each of the three parts being a respective branch of said corresponding one pipe.

9. The apparatus of claim 8, further configured such that the vaporizer and the heater respectively supply, to a given another one of said at least one torch, source material from said vaporizer and dilution gas from said heater together through a corresponding another one of said at least one pipe.

10. The apparatus of claim 9, configured so that said source material from said vaporizer and dilution gas from said heater mix in a part of the corresponding another pipe.

11. The apparatus of claim 10, wherein said corresponding another pipe comprises two additional parts for respectively conveying said source material from said vaporizer and dilution gas from said heater.

12. The apparatus of claim 11, wherein the three parts of said corresponding another pipe are joined together at a confluence as three respective branches.

13. The apparatus of claim 1, further configured such that the vaporizer and the heater respectively supply, to a given another one of said at least one torch, source material from said vaporizer and dilution gas from said heater together through a corresponding another one of said at least one pipe.

14. A system comprising the apparatus of claim 13, further comprising the created vaporized source material which is supplied to the given one torch, and said source material from said vaporizer which is supplied to the given another one torch, respective compositions of the two source materials leaving the vaporizer differing.

15. The apparatus of claim 13, wherein the soot preform has a core and a cladding, said apparatus being configured with the given one torch and the given another torch being disposed respectively for application to the core and the cladding.

16. The apparatus of claim 13, wherein said heating is to a temperature above a boiling point of the created vaporized source material.

17. The apparatus of claim 16, configured for maintaining said given one pipe at a temperature higher than a boiling point of the created vaporized source material, and for maintaining said given another one pipe at a temperature higher than a boiling point of said source material from said vaporizer.

18. The apparatus of claim 16, wherein said heating is to a temperature above a boiling point of said source material from said vaporizer.

19. The apparatus of claim 18, configured for maintaining said given one pipe at a temperature higher than a boiling point of the created vaporized source material, and for maintaining said given another one pipe at a temperature higher than said boiling point of said source material from said vaporizer.

20. The apparatus of claim 1, wherein the dilution gas comprises helium.
